(19) United States
(12) Patent Application Publication
(10) Pub. No.: US 2022/0402166 A1
(43) Pub. Date: Dec. 22, 2022

(54) ON DEMAND KIT FOR CUSTOMIZABLE CEMENTITIOUS COMPOSITIONS

(71) Applicant: Construction Research & Technology GmbH, Trostberg (DE)

(72) Inventors: Kim Struble, Midland, MI (US); Ravi Devalapura, New Albany, OH (US); Kenneth Calautti, Prior Lake, MN (US)

(21) Appl. No.: 17/838,343

(22) Filed: Jun. 13, 2022

Related U.S. Application Data
(60) Provisional application No. 63/213,196, filed on Jun. 21, 2021.

(51) Int. Cl. B28C 7/04; B65D 65/46; C04B 7/38

(52) U.S. Cl. CPC B28C 7/0404; B65D 65/46; C04B 7/38; C04B 2111/72

(57) ABSTRACT

A packaged additive for preparing a cementitious composition comprises a water-soluble paper container and at least one non-liquid additive packaged within the water-soluble paper container. A kit for preparing a hardenable cementitious composition comprises the packaged additive and a separate packaged base cementitious material. Also disclosed is a method for preparing a hardenable cementitious composition using the packaged additive and separate base cementitious material components of the kit, and a method for repairing a flaw in a cementitious structure using the hardenable cementitious composition prepared with the packaged additive and the separate base cementitious material.

### CROSS REFERENCE TO RELATED APPLICATIONS

This is a written application for patent filed pursuant to 35 U.S.C. § 111(a). This application claims the benefit of the filing date under 35 U.S.C. § 119(e) from U.S. Provisional Patent Application Ser. No. 63/213,196 filed Jun. 21, 2021, which is hereby incorporated by reference in its entirety.

### TECHNICAL FIELD

The present disclosure relates to a packaged performance-enhancing additive for preparing cementitious compositions, a kit including a packaged performance-enhancing additive and a separate base cementitious material, a method for preparing a cementitious composition including combining the packaged performance-enhancing additive and the base cementitious material, and a method of repairing a flaw in a cementitious structure with a cementitious composition prepared with the packaged performance-enhancing additive and the base cementitious material.

### BACKGROUND

Conventional cementitious compositions require differently formulated additive or admixture components to modify the properties of a cementitious material to produce the required performance properties for specialty cementitious materials, such as different consistencies for different end application methods including low pressure spray-applied shotcrete, form and pour repairs, vertical repairs, overhead repairs, pumped materials, trowel-applied mortars, and the like. The number of differently formulated components required at any given job site to achieve a variety of differently performing cementitious compositions for different end applications creates unnecessary mixing complexity and increased inventory of differently formulated materials.

Bags of pre-mixed cementitious materials in weights of 50 lbs or 80 lbs are commonly used for various applications, but customers must purchase different bags or pallets of bags for each performance requirement that they need for a project. What is needed is a way to use bags of base cementitious material that can be used with different performance-enhancing additives or admixtures, and to easily and efficiently customize, and transform the base material into specialty cementitious materials. This would enable the end user to modify the base material at the job site during mixing and would allow manufacturers of cementitious products to use modular production methods by separating base material from performance enhancing additives, thus reducing stock keeping units (SKUs) for manufacturers and end-users.

### SUMMARY

According to certain illustrative embodiments, disclosed is a packaged additive for preparing a cementitious composition comprising a water-soluble package comprising a blend of wood pulp and at least one additional package forming agent, and at least one performance-enhancing additive packaged within the water-soluble paper package.

According to certain illustrative embodiments, disclosed is a packaged additive for preparing a cementitious composition comprising a water-soluble package comprising a blend of wood pulp and at least one additional package forming agent, and at least one non-liquid performance-enhancing additive packaged within the water-soluble paper package.

According to other illustrative embodiments, disclosed is a kit for preparing a hardenable cementitious composition, the kit comprising a water-soluble package comprising a blend of wood pulp and at least one additional package forming agent, and at least one performance-enhancing additive packaged within the water-soluble paper package and a separate base cementitious material.

According to other illustrative embodiments, disclosed is a kit for preparing a hardenable cementitious composition, the kit comprising a water-soluble package comprising a blend of wood pulp and at least one additional package forming agent, and at least one non-liquid performance-enhancing additive packaged within the water-soluble paper package and a separate base cementitious material.

According to other illustrative embodiments, disclosed is a method for preparing a hardenable cementitious composition comprising providing a base cementitious material and a packaged performance-enhancing additive for preparing a cementitious composition comprising a water-soluble paper package comprising a blend of wood pulp and at least one additional package forming agent, and at least one performance-enhancing additive packaged within the water-soluble paper package; mixing together the base cementitious material, the packaged additive, and water, and allowing the water-soluble package to dissolve and the additive packaged within the water-soluble package to mix with the base cementitious material and water to form a hardenable cementitious composition.

According to other illustrative embodiments, disclosed is a method for repairing a flaw in a cementitious structure comprising providing a base cementitious material and a packaged performance-enhancing additive for preparing a cementitious composition comprising a water-soluble paper package comprising a blend of wood pulp and at least one additional package forming agent, and at least one performance-enhancing additive packaged within the water-soluble paper package; mixing together the base cementitious material, the packaged additive, and water, and allowing the water-soluble package to dissolve and the additive packaged within the water-soluble package to mix with the base cementitious material and water to form a hardenable cementitious composition; and applying the hardenable cementitious composition to the flaw.

### DETAILED DESCRIPTION

Disclosed is a packaged performance-enhancing additive for cementitious compositions. The packaged performance-enhancing additive may be combined on-demand with a separate base cementitious material to prepare customizable cementitious compositions. The prepared cementitious compositions exhibit desired performance properties that are imparted to the base cementitious compositions by the one or more performance-enhancing additives added to the base cementitious material.

Additionally disclosed is a kit that comprises a packaged performance-enhancing additive to prepare a customized cementitious composition and a separate base cementitious material. The separately packaged performance-enhancing additive and base cementitious material are intended to be combined on-demand to prepare a customized cementitious composition having desired performance properties which are imparted to the base cementitious material by the performance-enhancing additive that is combined with the separate base cementitious composition.

Additionally disclosed is a method for preparing on-demand a customized cementitious composition, the method comprises combining the packaged performance-enhancing additive and the base cementitious material with water, where the customized cementitious composition exhibits desired performance properties which are imparted by the performance-enhancing additive that is combined with the separate base cementitious composition. Mixing together the base cementitious material and the packaged performance-enhancing additive together with water allows the water-soluble package containing the additive to dissolve and performance-enhancing admixture or additive material packaged within the water-soluble package to be released to mix with the base cementitious material and water to form a customized hardenable cementitious composition.

Further disclosed is a method of repairing a flaw in a cementitious structure with a cementitious composition prepared with the packaged performance-enhancing additive and a base cementitious material, the method comprises combining the packaged performance-enhancing additive and the base cementitious material with water to provide a customized cementitious composition that exhibits desired performance properties which are imparted by the performance-enhancing additive that is combined with the separate base cementitious composition, and applying the prepared customized cementitious composition to a flaw in a cementitious structure.

The additive comprises a water-soluble container or package and at least one, performance-enhancing additive, such as a non-liquid performance-enhancing additive or admixture material, that is packaged within the water-soluble container or package. The water-soluble container or package containing performance-enhancing additive or admixture material comprises a water-soluble paper container or package. According to certain illustrative embodiments, the water soluble paper package for containing the performance-enhancing admixture or additive for preparing a customized cementitious composition is prepared from wood pulp and at least one additional package forming agent that is selected alkyl cellulose, salts of alkyl cellulose, carboxyalkylcellulose, salts of carboxyalkylcellulose, hydroxyalkylcellulose, salts of hydroxyalkylcellulose, poly(acrylic acid) and its copolymers, poly(methacrylic acid) and its copolymers, poly(vinyl alcohol), partially hydrolyzed poly(vinyl acetate) and its copolymers, starch, modified starch, pectin, amylopectin, and mixtures thereof.

According to certain embodiments, the package for containing the performance-enhancing admixture or additive for preparing a customized cementitious composition is prepared from wood pulp and carboxyalkyl cellulose.

According to certain embodiments, the package for containing the performance-enhancing admixture or additive for preparing a customized cementitious composition is prepared from wood pulp and carboxymethyl cellulose.

According to certain embodiments, the package for containing the performance-enhancing admixture or additive for preparing a customized cementitious composition is prepared from wood pulp and the sodium salt of carboxymethyl cellulose.

According to certain illustrative embodiments, the water-soluble package containing the performance-enhancing admixture or additive may be contained within a water-insoluble overpack material to protect the water-soluble package from dissolution from the time of initial packaging of the performance-enhancing admixture or additive until just prior to the time that the water-soluble package is combined with a base cementitious material and water to prepare customized hardenable cementitious composition having the desire performance properties imparted by the performance-enhancing additive or admixture.

The material used to prepare the water-soluble container or package for packaging the performance-enhancing admixture or additive for preparing a customized cementitious composition may be configured in any suitable form that has an inner volume for containing a desired amount of the performance-enhancing admixture or additive. According to certain illustrative embodiments, the water-soluble may be configured as a bag, a sack, a sachet, a box, a packet, a pouch, or a pod.

According to certain illustrative embodiments, the non-liquid additive or admixture material comprises at least one of a set accelerator, set retarder, air-entraining agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, wetting agent, strength enhancing agent, toughening aid, thickening agent, density modifier, preservative, water repellent, or mixtures thereof.

According to certain illustrative embodiments, the non-liquid admixture material comprises admixture material components suitable to transform the base cementitious material into a customized cementitious material comprising end application desired performance characteristics that are imparted by the performance-enhancing admixture or additive material.

The customized cementitious material is selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.

According to certain embodiments, the packaged performance-enhancing admixture or additive for preparing a customized cementitious composition comprises a water-soluble paper package comprising a blend of wood pulp and at least one additional packaging forming agent, and a performance-enhancing admixture or additive packaged and inert filler packaged within the water-soluble paper package.

According to certain embodiments, the amount of the performance-enhancing admixture or additive contained within the water-soluble paper package is in the range of about 5 weight percent to about 70 weight percent and the amount of the inert filler contained within the water-soluble paper package is in the range of about 30 weight percent to about 95 weight percent, based on the total amount of the performance-enhancing admixture or additive and inert filler, or the amount of the performance-enhancing admixture or additive contained within the water-soluble paper package is in the range of about 10 weight percent to about 70 weight percent and the amount of the inert filler contained within the water-soluble paper package is in the range of about 30 weight percent to about 90 weight percent, based on the total amount of the performance-enhancing admixture or additive and inert filler, or the amount of the performance-enhancing admixture or additive contained within the water-soluble paper package is in the range of about 30 weight percent to about 70 weight percent and the amount of the inert filler contained within the water-soluble paper package is in the range of about 30 weight percent to about 70 weight percent, based on the total amount of the performance-enhancing admixture or additive and inert filler, or the amount of the performance-enhancing admixture or additive contained within the water-soluble paper package is in the range of about 40 weight percent to about 70 weight percent and the amount of the inert filler contained within the water-soluble paper package is in the range of about 30 weight percent to about 60 weight percent, based on the total amount of the performance-enhancing admixture or additive and inert filler, or the amount of the performance-enhancing admixture or additive contained within the water-soluble paper package is in the range of about 50 weight percent to about 70 weight percent and the amount of the inert filler contained within the water-soluble paper package is in the range of about 30 weight percent to about 50 weight percent, based on the total amount of the performance-enhancing admixture or additive and inert filler.

Without limitation, the water-soluble paper package may contain a total of 15 grams of the performance-enhancing admixture or additive and inert filler, with the amount of the performance-enhancing admixture or additive present in an amount of 2 grams to 10 grams and the inert filler present in the amount of about 5 grams to about 13 grams.

For illustrative embodiments where the performance-enhancing additive comprises polymeric reinforcing fibers for the final cementitious composition, the water-soluble paper package may contain a total of 15 grams of the reinforcing fibers and inert filler, with the amount of the reinforcing fibers present in an amount of up to 2 and the inert filler present in the amount of 13 grams or more.

According to other embodiments, the packaged performance-enhancing admixture or additive for preparing a customized cementitious composition comprises a water-soluble paper package comprising a blend of wood pulp and at least one additional packaging forming agent, and a performance-enhancing admixture or additive packaged and inert colored filler packaged within the water-soluble paper package. Without limitation the colored filler may comprise colored quartz. The colored filler may act as a tracer material. The colored tracer material may be blended with the performance-enhancing admixture or additive, and then the mixture packaged within the water-soluble paper package. The color of the tracer material, such as a colored quartz, may identify the type of performance-enhancing admixture or additive present within the water-soluble paper package. The inclusion of the tracer material within the packaged performance-enhancing admixture or additive enables the user to positively identify the particular type admixture or additive used to prepare a customized hardenable cementitious composition. For example, a packaged performance enhancing additive or admixture for cementitious compositions may be sealed within the water-soluble paper package along with a suitable amount of colored tracer material that identifies or otherwise corresponds to the packaged additive or admixture. The packaged performance-enhancing admixture or additive is blended with a separately packaged base cementitious material and water to prepare a hardenable cementitious composition and the hardenable cementitious composition is placed and permitted to harden. After hardening, the inclusion of the colored tracer material throughout the hardened cementitious composition enables to user with the capability of making a simple analysis of the hardened cementitious product to determine the color of the tracer material and thereby positively identify the type of performance-enhancing admixture or additive used to prepare the hardened cementitious composition. The packaged performance-enhancing admixture or additive can be analyzed in the dry powder form prior to use to make the same determination. The colored tracer material may be in the form of beads, fibers, flakes, particles, rods, spheres, and the like. The beads, fibers, flakes, particles, rods, or spheres of tracer material may be a natural material, a synthetic material, or a combination of both materials. The natural material may comprise an inorganic material.

The kit for preparing a customized hardenable cementitious composition includes a water-soluble container and at least one non-liquid performance-enhancing admixture or additive material packaged within the water-soluble container that is formulated to impart a desired performance property to a base cementitious material. The kit also includes a separately packaged base cementitious material for combination with the packaged performance-enhancing admixture or additive. By way of illustration, but not in limitation, the separately-packaged performance-enhancing admixture or additive and the separately packaged base material may be shrink-wrapped together to form a kit unit. According to other embodiments, the separately-packaged performance-enhancing admixture or additive and the separately packaged base material may be placed together within an overpack structure such as a box. According to yet further embodiments, the water-soluble package containing the separately-packaged performance-enhancing admixture or additive may be placed inside of the packaging for the separately packaged base cementitious material. For illustrative embodiments where the separately-packaged performance-enhancing admixture or additive is provided inside of the separately packaged base cementitious material, the packaged performance-enhancing admixture or additive may be affixed to the inside surface of the packaging for the base cementitious material. For example, the base cementitious material may be packaged in flexible bags and the separately-packaged performance-enhancing admixture or additive may be affixed to the inner surface of the flexible bag with an adhesive material or any other means of affixing the packaged admixture or additive to the inner surface of the cementitious material package.

The term “base cementitious material” as used throughout this specification refers to a hydraulic cementitious binder, optionally containing aggregate, of a fixed formulation that may be combined with water and one or more different packaged performance-enhancing admixtures or additives having different performance-enhancing properties to achieve a desired application performance without further modification of the base cementitious material.

In certain illustrative embodiments, the base cementitious material comprises at least one of Portland cement, modified Portland cement, masonry cement, alumina cement, refractory cement, magnesium phosphate cement, magnesium potassium phosphate cement, calcium aluminate cement, calcium sulfoaluminate cement, calcium sulfate hemi-hydrate cement, oil well cement, ground granulated blast furnace slag cement, natural cement, hydraulic hydrated lime, or mixtures thereof. In certain embodiments, the cementitious material comprises Portland cement.

In certain illustrative embodiments, the base cementitious material comprises an aggregate component. In certain embodiments, the aggregate comprises at least one of fine aggregate, coarse aggregate or a mixture thereof.

According to certain embodiments, the amount of hydraulic cement present in the base cementitious material is from about 10 weight percent to about 90 weight percent and the amount of aggregate present in the base cementitious material is from about 90 weight percent to about 10 weight percent, based on the total weight of the dry base cementitious material, or the amount of hydraulic cement present in the base cementitious material is from about 20 weight percent to about 80 weight percent and the amount of aggregate present in the base cementitious material is from about 80 weight percent to about 20 weight percent, based on the total weight of the dry base cementitious material, or the amount of hydraulic cement present in the base cementitious material is from about 30 weight percent to about 70 weight percent and the amount of aggregate present in the base cementitious material is from about 70 weight percent to about 30 weight percent, based on the total weight of the dry base cementitious material, or the amount of hydraulic cement present in the base cementitious material is from about 40 weight percent to about 60 weight percent and the amount of aggregate present in the base cementitious material is from about 60 weight percent to about 40 weight percent, based on the total weight of the dry base cementitious material.

According to certain illustrative embodiments, the dry base cementitious material may also include at least one water-reducer for cementitious compositions, so long as the total amount of hydraulic cement, aggregate and water reducer does not exceed 100 weight percent based on the dry weight of the base cementitious material.

According to certain illustrative embodiments, the aggregate component of the dry base cementitious composition may comprise an aggregate component having a gradation of aggregate particle sizes. According to certain embodiments, the aggregate component of the dry base cementitious composition comprises a gradation of aggregate particle sizes having at least three different aggregate particle sizes (referred to as sand aggregate 1, sand aggregate 2 and sand aggregate 3). According to certain illustrative embodiments, the aggregate particle size gradation of the aggregate component of the base cementitious composition comprises sand aggregate 1 in the amount of about 30 weight percent to about 35 weight percent, sand aggregate 2 in the amount of about 25 weight percent to about 30 weight percent, and sand aggregate 3 in the amount of about 15 weight percent to about 20 weight percent. According to certain illustrative embodiments, the aggregate particle size gradation of the aggregate component of the base cementitious composition comprises sand aggregate 1 in the amount of about 28 weight percent to about 34 weight percent, sand aggregate 2 in the amount of about 22 weight percent to about 28 weight percent, and sand aggregate 3 in the amount of about 12 weight percent to about 18 weight percent.

The method for preparing a hardenable cementitious composition comprises providing a base cementitious material, non-liquid performance-enhancing admixture or additive material capable of imparting a desired performance property to a cementitious composition packaged within a water-soluble container or package, mixing together the base cementitious material, the packaged performance-enhancing admixture or additive and water, and allowing the water-soluble package containing the performance-enhancing additive therein to dissolve and the non-liquid admixture or additive material packaged within the water-soluble package to be released from the package to mix with the base cementitious material and water to form a customized hardenable cementitious composition with the performance properties imparted to the base cementitious composition by the performance-enhancing admixture or additive.

The method for repairing a flaw in a cementitious structure comprises providing a base cementitious material, non-liquid performance-enhancing admixture or additive material capable of imparting a desired performance property to a cementitious composition packaged within a water-soluble container or package, mixing together the base cementitious material, the packaged performance-enhancing admixture or additive and water, and allowing the water-soluble package containing the performance-enhancing additive therein to dissolve and the non-liquid admixture or additive material packaged within the water-soluble package to be released from the package to mix with the base cementitious material and water to form a customized hardenable cementitious composition with the performance properties imparted to the base cementitious composition by the performance-enhancing admixture or additive, applying the customized hardenable cementitious composition to the flaw, and allowing the customized hardenable cementitious composition to harden.

For simplicity of use, it is desirable for the water-soluble container to contain all of the admixture components necessary to transform a base cementitious material into a customized cementitious material having desired end use performance properties imparted by the packaged admixture or additive, so that an end-user can simply mix a base cementitious material with water and the water-soluble package containing all of the admixture components necessary to transform the base cementitious material into the customized cementitious material comprising end application dictated performance characteristics that are imparted by the admixture material, thereby obtaining a customized cementitious material with the use of only one bag of base cementitious material, one water-soluble container containing all of the required admixture components, and water. A user can therefore prepare a base cementitious composition with one bag of base cementitious material and water, or a specialty cementitious composition with the same bag of cementitious material, water and the packaged additive comprising a container that easily dissolves in water to provide the packaged admixture or additive component(s).

The water-soluble container may be dissolved in water of any temperature without pH adjustment. Dissolution is facilitated by the mixing required for cementitious materials, and is faster at higher temperatures.

Non-liquid admixture or additive components are used in the water-soluble container to prevent premature dissolution of the container. Solid admixture components of any form such as powders, pellets, crystals, fibers, and the like may be easily packaged in the water-soluble container. For ease of use, transfer, and packaging, liquid admixture components may be combined with solid material to form particles, pellets, pills, rods, controlled release particles, and the like to facilitate introduction into the water-soluble container in a solid form. The water-soluble container may comprise a bag, a sack, a sachet, a box, a packet, a pouch, a pod, or any other suitable shape of container, and over-packaging may be employed to protect the water-soluble container until it is ready to be used.

In certain embodiments, the types of admixture or additive material components that can be packaged in the water-soluble container include, but are not limited to, set accelerators, set retarders, air-entraining agents, defoamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, wetting agents, strength enhancing agents, toughening aids, thickening agents, density modifiers, preservatives, water repellents, and the like.

Set accelerators are used to accelerate the setting and early strength development of concrete. Examples of set accelerators include, but are not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulfate of an alkali metal, alkaline earth metal, or aluminum; a hydroxide of an alkali metal, alkaline earth metal, or aluminum; a carboxylic acid salt of an alkali metal, alkaline earth metal, or aluminum; a polyhydroxylalkylamine; or a halide salt of an alkali metal or alkaline earth metal. In certain embodiments, a set accelerator admixture component may comprise at least one of lithium carbonate, calcium formate, a chloride salt of an alkali metal, or a chloride salt of an alkaline earth metal.

The salts of nitric acid have the general formula M(NO₃)ₐ where M is an alkali metal, or an alkaline earth metal or aluminum, and where a is 1 for alkali metal salts, 2 for alkaline earth salts, and 3 for aluminum salts. Nitric acid salts of Na, K, Mg, Ca and Al may be used.

Nitrite salts have the general formula M(NO₂)ₐ where M is an alkali metal, or an alkaline earth metal or aluminum, and where a is 1 for alkali metal salts, 2 for alkaline earth salts, and 3 for aluminum salts. Nitrous acid salts of Na, K, Mg, Ca and Al may be used.

The salts of thiocyanic acid have the general formula M(SCN)_{b}, where M is an alkali metal, or an alkaline earth metal or aluminum, and where b is 1 for alkali metal salts, 2 for alkaline earth salts and 3 for aluminum salts. These salts are variously known as sulfocyanates, sulfocyanides, rhodanates or rhodanide salts. Thiocyanic acid salts of Na, K, Mg, Ca and Al may be used.

Alkanolamine is a generic term for a group of compounds in which trivalent nitrogen is attached directly to a carbon atom of an alkyl alcohol. A representative formula is N[H]_{c}[(CH₂)_{d}CHRCH₂R]ₑ, where R is independently H or OH, c is 3-e, d is 0 to about 4 and e is 1 to about 3. Examples include, but are not limited to, monoethanoalamine, diethanolamine, triethanolamine, and triisopropanolamine. A polyhydroxylalkylamine that may be used is tetrahydroxyethylethylenediamine.

The thiosulfate salts have the general formula M_{f}(S₂O₃)_{g} where M is alkali metal or an alkaline earth metal or aluminum, and f is 1 or 2 and g is 1, 2 or 3, depending on the valencies of the M metal elements. Thiosulfate acid salts of Na, K, Mg, Ca and Al may be used.

The carboxylic acid salts have the general formula RCOOM wherein R is H or C₁ to about C₁₀ alkyl, and M is alkali metal or an alkaline earth metal or aluminum. Carboxylic acid salts of Na, K, Mg, Ca and Al may be used. A carboxylic acid salt that may be used is calcium formate.

Set retarding, also known as delayed-setting or hydration control, admixtures are used to retard, delay, or slow the rate of setting of concrete. Set retarders are used to offset the accelerating effect of hot weather on the setting of concrete, or delay the initial set of concrete or grout when difficult conditions of placement occur, or problems of delivery to the job site, or to allow time for special finishing processes. Most set retarders also act as low level water reducers and can also be used to entrain some air into concrete. Retarders that can be used include, but are not limited to, an oxy-boron compound, corn syrup, lignin, a polyphosphonic acid, a carboxylic acid, a hydroxycarboxylic acid, polycarboxylic acid, hydroxylated carboxylic acid, such as fumaric, itaconic, malonic, borax, gluconic, and tartaric acid, cream of tartar, lignosulfonates, ascorbic acid, isoascorbic acid, sulphonic acid-acrylic acid copolymer, and their corresponding salts, polyhydroxysilane, polyacrylamide, carbohydrates and mixtures thereof.

The term air entrainer includes any chemical that will entrain air in cementitious compositions. Air entrainers can also reduce the surface tension of a composition at low concentration. Air-entraining admixtures are used to purposely entrain microscopic air bubbles into concrete. Air-entrainment can modify density and dramatically improves the durability of concrete exposed to moisture during cycles of freezing and thawing. In addition, entrained air greatly improves the resistance of concrete to surface scaling caused by chemical deicers. Air entrainment also increases the workability of fresh concrete while eliminating or reducing segregation and bleeding. Materials used to achieve these desired effects can be selected from wood resin, natural resin, synthetic resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition.

Air detrainers are used to decrease the air content in the mixture of concrete. Tributyl phosphate, dibutyl phthalate, octyl alcohol, water-insoluble esters of carbonic and boric acid, and silicones are some of the common materials that can be used to achieve this effect.

Defoamers are used to decrease the air content in the cementitious composition. Examples of defoamers that can be utilized in the cementitious composition include, but are not limited to mineral oils, vegetable oils, fatty acids, fatty acid esters, hydroxyl functional compounds, amides, phosphoric esters, metal soaps, silicones, polymers containing propylene oxide moieties, hydrocarbons, alkoxylated hydrocarbons, alkoxylated polyalkylene oxides, tributyl phosphates, dibutyl phthalates, octyl alcohols, water-insoluble esters of carbonic and boric acid, acetylenic diols, ethylene oxide-propylene oxide block copolymers and silicones.

Alkali reactivity reducers can reduce the alkali aggregate reaction and limit the disruptive expansion forces that this reaction can produce in hardened concrete. The alkali-reactivity reducers include pozzolans such as fly ash and silica fume, blast furnace slag, and salts of lithium and barium.

Bonding admixtures are usually added to increase the bond strength between old and new concrete, and include organic materials such as rubber, polyvinyl chloride, polyvinyl acetate, acrylics, styrene butadiene copolymers, and other powdered polymers.

The term dispersant includes polycarboxylate dispersants and is also meant to include those chemicals that also function as a plasticizer, water reducer, fluidizer, antiflocculating agent, or superplasticizer for cementitious compositions, such as lignosulfonates, salts of sulfonated naphthalene sulfonate condensate, and salts of sulfonated melamine sulfonate condensate. Polycarboxylate dispersants have a carbon backbone with pendant side chains, wherein at least a portion of the side chains are attached to the backbone through a carboxyl group or an ether group. Polycarboxylate ether (PCE) materials act as plasticizing flow enhancers and water reducers, increasing the slump value of a concrete.

Natural and synthetic admixtures are used to color concrete for aesthetic and safety reasons. These coloring admixtures are usually composed of pigments and include carbon black, iron oxide, phthalocyanine, umber, chromium oxide, titanium oxide, cobalt blue, and organic coloring agents.

Corrosion inhibitors in concrete serve to protect embedded reinforcing steel from corrosion due to its highly alkaline nature. The high alkaline nature of the concrete causes a passive and noncorroding protective oxide film to form on the steel. However, carbonation or the presence of chloride ions from deicers or seawater can destroy or penetrate the film and result in corrosion. Corrosion inhibiting admixtures chemically arrest this corrosion reaction. The materials most commonly used to inhibit corrosion are calcium nitrite, sodium nitrite, sodium benzoate, certain phosphates or fluorosilicates, fluoroaluminites, amines and related chemicals.

By way of illustration, and without limitation, the corrosion inhibitor may be selected from alkyl acetamides, alkyl carboxylic acids and salts, alkoxy carboxylic acids and salts, alkoxylates, phosphorus containing compounds, triazines, and mixtures thereof. In some embodiments, the phosphorus containing compounds may comprise at least one of alkyl phosphonic acids and phosphate esters. In some embodiments, the phosphate esters comprise at least one of polyether phosphates, alkyl phosphate esters, and amine-blocked alkyl phosphate esters.

In certain embodiments, the corrosion inhibitor is selected from dimethyl acetamide, diethyl acetamide, disodium sebacate, iso-nonyl phenoxy acetic acid, ethynylcarbinolalkoxylate, octane phosphonic acid, mono-n-octyl phosphate ester, amine blocked C6-C10 alkyl phosphate monoester, triisobutyl phosphate, polyether phosphate, 1,3,5-Tris[3-(dimethylamino)propyl]hexahydro-1,3,5-triazine, and mixtures thereof.

Dampproofing admixtures reduce the permeability of concrete that have low cement contents, high water cement ratios, or a deficiency of fines in the aggregate. These admixtures retard moisture penetration into dry concrete and include certain soaps, stearates, and petroleum products.

Gas formers, or gas forming agents, are sometimes added to concrete and grout in very small quantities to cause a slight expansion prior to hardening. The amount of expansion is dependent upon the amount of gas forming material used and the temperature of the fresh mixture. Aluminum powder, resin soap and vegetable or animal glue, saponin or hydrolyzed protein can be used as gas formers.

Permeability reducers are used to reduce the rate at which water under pressure is transmitted through concrete. Silica fume, fly ash, ground slag, natural pozzolans, and water reducers can be employed to decrease the permeability of the concrete. Pozzolan is a siliceous or siliceous and aluminous material, which in itself possesses little or no cementitious value. However, in finely divided form and in the presence of moisture, pozzolan will chemically react with calcium hydroxide at ordinary temperatures to form compounds possessing cementitious properties.

Pumping aids are added to concrete mixes to improve pumpability. These admixtures may also be regarded as thickening agents as they thicken the fluid concrete, increasing its viscosity to reduce de-watering of the paste while it is under pressure from a pump. Among the materials used as pumping aids in concrete are organic and synthetic polymers, hydroxyethylcellulose (HEC) or HEC blended with dispersants, organic flocculants, paraffin, coal tar, asphalt, acrylics, bentonite and pyrogenic silicas, natural pozzolans, fly ash and hydrated lime.

Shrinkage compensation agents which can be used in the cementitious composition can include, but are not limited to, RO(AO)₁₋₁₀H, wherein R is a C₁₋₅ alkyl or C₅₋₆ cycloalkyl radical and A is a C₂₋₃ alkylene radical, alkali metal sulfates, alkaline earth metal sulfates, alkaline earth oxides. In certain embodiments the shrinkage compensation agent is at least one of sodium sulfate or calcium oxide.

Bacteria and fungal growth in concrete mixtures or on or in hardened concrete may be partially controlled through the use of fungicidal, germicidal, and insecticidal admixtures and preservatives. The most effective materials for these purposes are polyhalogenated phenols, phenol salts such as sodium orthophenylphenate (SOPP), and copper compounds.

Rheology modifying agents can be used to increase the viscosity of cementitious compositions. Suitable examples of rheology modifier include fumed silica, colloidal silica, hydroxyethyl cellulose, hydroxypropyl cellulose, fly ash, mineral oils such as light naphthenic oil, hectorite clay, polyoxyalkylenes, polysaccharides, natural gums, and mixtures thereof.

Fresh concrete can sometimes be harsh because of faulty mixture proportions or certain aggregate characteristics such as particle shape and improper grading. Under these conditions, entrained air which acts like a lubricant, can be used as a workability improving agent. Other workability agents are water reducers and certain finely divided admixtures.

Finely divided mineral admixtures are materials in powder or pulverized form added to concrete to improve or change some of the plastic or hardened properties. The finely divided mineral admixtures can include pozzolans and nominally inert materials.

A pozzolan is a siliceous or aluminosiliceous material that possesses little or no cementitious value but will, in the presence of water and in finely divided form, chemically react with the calcium hydroxide released by the hydration of Portland cement to form materials with cementitious properties. Pozzolans can also be used to reduce the rate at which water under pressure is transferred through concrete. Diatomaceous earth, opaline cherts, clays, shales, fly ash, silica fume, volcanic tuffs and pumicites are some of the known pozzolans. Certain ground granulated blast furnace slags and high calcium fly ashes possess both pozzolanic and cementitious properties. Nominally inert materials can also include finely divided raw quartz, dolomites, limestone, marble, granite, and others. Fly ash is defined in ASTM C618.

Wetting agents are surface active agents capable of lowering the surface tension of liquids, used to improve the wetting of fine particles in cementitious mixes. These surfactants improve workability, penetration and binding strength of concrete to surfaces and lead to a higher performance.

In the construction field, many methods of toughening concrete have been developed through the years. One modern method involves distributing fibers throughout a fresh concrete mixture as a strength enhancing agent and toughening aid. Fibers may also be regarded as thickening agents. Upon hardening, this concrete is referred to as fiber reinforced concrete. Different types of fibers may be selected to serve different purposes. Generally, fibers are relatively strong in tension compared to the hardening cementitious binder; therefore one benefit of fiber addition is to improve tensile properties of the cementitious composition through fiber bond with the cementitious matrix. The bonding of the fibers to the cementitious matrix is affected by the surface area of the fiber, the surface texture of the fiber, the amount of mechanical interlock between the fiber and the cementitious matrix, the chemical properties of the fiber and the cementitious matrix, the tensile elongation characteristics of the fiber, the elastic modulus of the fiber, and other factors. Fibers can be made of zirconia containing materials, carbon, ceramic, fiberglass, metals such as steel, metal alloys, or synthetic polymer materials such as polypropylene, nylon, polyethylene, polyester, polyacrylonitirile (PAN), rayon, and high strength aramid such as Kevlar®. Mixtures of fibers can also be used.

Physical and chemical properties of cementitious materials change as the material cures and ages. The early age strength is typically lower than the later age strength. Therefore, lower modulus fibers with satisfactory bonding characteristics are helpful for early age properties such as plastic shrinkage cracking control. Higher modulus fibers with satisfactory bonding characteristics to the cementitious matrix can distribute the tensile stresses from drying shrinkage or flexural strains to improve the hardened properties of the repair material. Additionally, known to those having skill in the art, some low melting point fibers can serve as ventilation channels to allow the escape of entrapped and combined water that can cause spalling when the cementitious matrix is exposed to high temperatures, such as are found in a fire. Fibers can also be helpful in distribution of impact type loads. Fibers also modify the rheology of the freshly mixed cementitious material causing a thickening action as well as improving the cohesiveness of the cementitious material, which may be a desirable property in some applications.

Density modifiers may include light weight particles such as hollow glass bubbles to reduce density, as well as air-entraining agents and gas formers.

Water repellent admixtures protect cementitious structures from the damaging effects of water penetration, leakage, and capillary absorption, and can include hydrocarbon materials and silicones.

The cementitious component of the base cementitious material comprises a hydraulic cementitious binder. The term “hydraulic cement” is used in its usual sense to denote the class of structural materials which are applied in mixture with water, and thereafter harden or set as a result of physical or chemical changes which consume the water present. In certain embodiments, the hydraulic cementitious binder of the base cementitious material may be selected from at least one of Portland cement, modified Portland cement, masonry cement, alumina cement, refractory cement, magnesium phosphate cement, magnesium potassium phosphate cement, calcium aluminate cement, calcium sulfoaluminate cement, calcium sulphate cements such as calcium sulfate hemi-hydrate cement, oil well cement, ground granulated blast furnace slag cement, natural cement, hydraulic hydrated lime, rapid hardening cements, low-heat cements, sulphate resisting cements, lime cements. selenitic cement. pozzolanic cements, or mixtures thereof. In certain embodiments, the hydraulic cementitious binder material comprises Portland cement.

Rapid hardening cements are those having high alumina contents. Low-heat cements are characterized by high percentages of dicalcium silicate and tetracalcium alumino ferrite, and low percentages of tricalcium silicate and tricalcium aluminate. Sulphate resisting cements are characterized by unusually high percentages of tricalcium silicate and dicalcium silicate, and unusually low percentages of tricalcium aluminate and tetracalcium alumino ferrite. Portland blast-furnace cement comprises a mixture of Portland cement clinker and granulated slag. Masonry cements are mixtures of Portland cement and one or more of hydrated lime, granulated slag, pulverized limestone, colloidal clay, diatomaceous earth or other finely divided forms of silica, calcium stearate and paraffin. Natural cements are characterized by material obtained from deposits in the Lehigh Valley, U.S.A. Lime cements comprise an oxide of calcium in its pure or impure forms, whether or not containing some argillaceous material. Selenitic cement is characterized by the addition of 5-10% of plaster of Paris to lime. Pozzolanic cement comprises a mixture of pozzolan, Portland cement, calcium hydroxide, water, trass kieselguhr, pumice, tufa, santorin earth or granulated slag with lime mortar. Calcium sulphate cements are characterized by the hydration of calcium sulphate, and include plaster of Paris, Keene's cement and Parian cement.

One or more of coarse and/or fine aggregate may be included in the base cementitious composition. Fine aggregate are materials that almost entirely pass through a Number 4 sieve (ASTM C 125 and ASTM C 33), such as silica sand. Coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands and the like.

By way of illustration, and without limitation, the customizable cementitious composition may be selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.

Bags of pre-mixed customized cementitious materials in weights of 50 lbs or 80 lbs are presently used for various applications, but customers must purchase different bags or pallets of bags of each customized cementitious materials to satisfy each performance requirement that they need for a project. By utilizing the presently disclosed packaged performance-enhancing admixture or additive, kit, and methods described above, end-users can use bags of base cementitious material universally with different packaged admixtures or additives to easily and efficiently customize and transform the base cementitious material on demand into a customized cementitious composition without having to alter the composition of the base cementitious material. This enables the end user to modify the base material at the on demand at the job site during mixing and allows manufacturers of cementitious products to use modular production methods by separating base material from performance enhancing additives, thus reducing stock keeping units (SKUs) for manufacturers and end-users by providing universal base cementitious material that has a flexible composition such that it can be used with different, separately packaged performance-enhancing admixtures or additives, and water-soluble packages of admixtures or additives to transform the base material to numerous customized cementitious materials.

In various specific embodiments, packaged in this water-soluble container are independently or in combination, polycarboxylate ether (PCE) for flow enhancement, corrosion inhibitors, polymers, accelerators, retarders, controlled release accelerators, controlled release retarders, PCE and defoamer, calcium oxide, lithium carbonate accelerator, polymers with defoamers and accelerators, PCE with corrosion inhibitor and accelerator, 5 mm metal fibers, polypropylene minifibers, polyacrylonitrile fibers, glass fibers, cream of tartar retarder, tartaric acid retarder, and dry polymers.

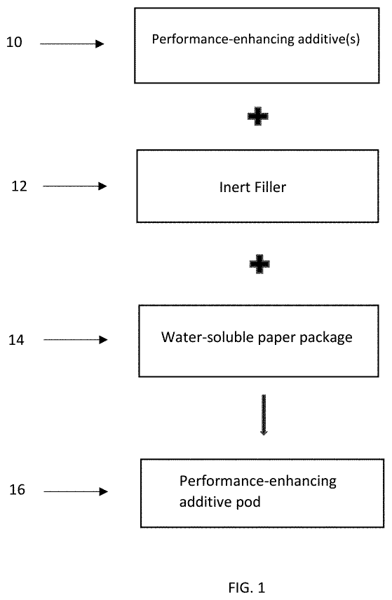

FIG. 1 is a schematic representation of the preparation of a packaged performance enhancing admixture or additive for cementitious compositions. Performance enhancing admixture or additive 10 is combined with inert filler 12 and sealed in a water-soluble package 14 to prepare a packaged performance enhancing admixture or additive 16 for cementitious compositions.

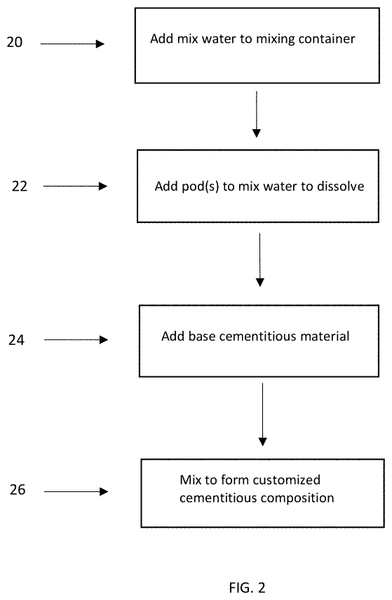

FIG. 2 is a flow chart for the preparation of an on-demand customizable cementitious composition using a packaged performance-enhancing admixture or additive (ie, pod) and a base cementitious material. According to certain embodiments, mix water is added to a mixing container at step 20. A water-soluble pod containing a desired performance enhancing admixture or additive is added to the mix water at step 22 and the pod is dissolved to release the performance-enhancing additive from the pod into the mixing water. The base cementitious material is added to the mixing water containing the dissolved pod at step 24, with mixing to prepare a customized cementitious composition at step 26.

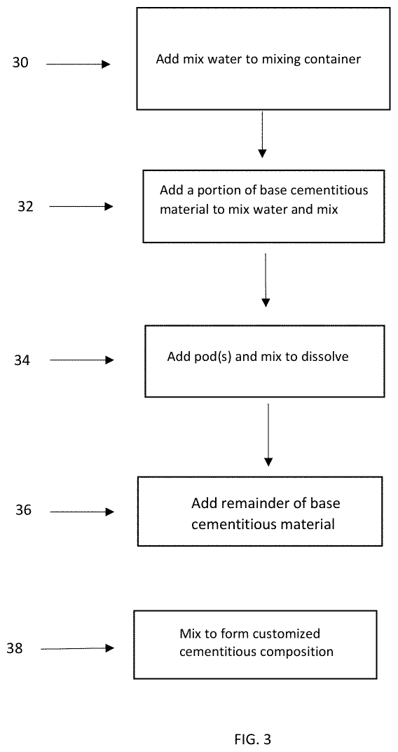

FIG. 3 is a flow chart for another illustrative method of preparation of an on-demand customizable cementitious composition using a packaged performance-enhancing admixture or additive (ie, pod) and a base cementitious material. According to certain embodiments, mix water is added to a mixing container at step 30. A portion of the desired amount of the base cementitious material is added to the mix water at step 32. A water-soluble pod containing a desired performance enhancing admixture or additive is added to the mix water at step 34 and the pod is dissolved to release the performance-enhancing additive from the pod into the mix of mixing water and has cementitious material. The remainder of the desired amount of the base cementitious material is added to the mixing water containing the dissolved pod at step 36, with further mixing to prepare a customized cementitious composition at step 38.

It will be understood that the various embodiments described herein are merely exemplary, and that one skilled in the art may make variations and modifications without departing from the spirit and scope of the disclosure. All such variations and modifications are intended to be included within the scope hereof. Furthermore, all embodiments disclosed are not necessarily in the alternative, as various embodiments described herein may be combined to provide the desired result. Therefore, the additive for a cementitious composition, kit for preparing a hardenable cementitious composition, and methods for preparing a hardenable cementitious composition and repairing a flaw in a cementitious structure should not be limited to any single embodiment, but rather construed in breadth and scope in accordance with the recitation of the attached claims.

We claim:

1. A packaged additive for preparing a cementitious composition comprising:
a water-soluble paper package comprising a blend of wood pulp and at least one additional package forming agent; and
at least one non-liquid performance-enhancing additive packaged within the water-soluble paper package.

2. The packaged additive of claim 1, wherein the at least one additional package forming agent is selected from the group consisting of alkylcellulose, salts of alkyl cellulose, carboxyalkylcellulose, salts of carboxyalkylcellulose, hydroxyalkylcellulose, salts of hydroxyalkylcellulose, poly(acrylic acid) and its copolymers, poly(methacrylic acid) and its copolymers, poly(vinyl alcohol), partially hydrolyzed poly(vinyl acetate) and its copolymers, starch, modified starch, pectin, amylopectin, and mixtures thereof.

3. The packaged additive of claim 2, wherein the at least one additional package forming agent comprises carboxyalkyl cellulose.

4. The packaged additive of claim 3, wherein the carboxyalkyl cellulose comprises a carboxymethyl cellulose.

5. The packaged additive of claim 4, wherein the carboxymethyl cellulose comprises the sodium salt of carboxymethyl cellulose.

6. The packaged additive of claim 5, wherein the water-soluble package comprises at least one of a bag, a sack, a sachet, a box, a packet, a pouch, or a pod.

7. The packaged additive of claim 1, wherein the non-liquid performance enhancing additive comprises at least one of a set accelerator, set retarder, air-entraining agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, wetting agent, strength enhancing agent, toughening aid, thickening agent, density modifier, preservative, water repellent, or mixtures thereof.

8. The packaged additive of claim 1, wherein the non-liquid performance enhancing additive is suitable to transform a base cementitious material into a specialty cementitious material comprising end application dictated performance characteristics that are imparted by the non-liquid additive, wherein the specialty cementitious material is selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.

9. A kit for preparing a hardenable cementitious composition comprising:
the packaged additive of claim 1; and
a separately packaged base cementitious material.

10. The kit of claim 9, wherein the separately packaged base cementitious material comprises at least one of Portland cement, modified Portland cement, masonry cement, alumina cement, refractory cement, magnesium phosphate cement, magnesium potassium phosphate cement, calcium aluminate cement, calcium sulfoaluminate cement, calcium sulfate hemi-hydrate cement, oil well cement, ground granulated blast furnace slag cement, natural cement, hydraulic hydrated lime, or mixtures thereof.

11. The kit of claim 9, wherein the separately packaged base cementitious material comprises an aggregate component.

12. The kit of claim 9, wherein the packaged additive comprises at least one of a set accelerator, set retarder, air-entraining agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, wetting agent, strength enhancing agent, toughening aid, thickening agent, density modifier, preservative, water repellent, or mixtures thereof.

13. The kit of claim 9, wherein the packaged additive comprises admixture material components suitable to transform the base cementitious material into a specialty cementitious material comprising end application dictated performance characteristics that are imparted by the admixture material, wherein the specialty cementitious material is selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.

14. A method for preparing a hardenable cementitious composition comprising:
providing a base cementitious material and the packaged additive of claim 1;
mixing together the base cementitious material, the packaged additive, and water; and
allowing the water-soluble paper package to dissolve and the at least one non-liquid performance-enhancing additive packaged within the water-soluble paper package to mix with the base cementitious material and water to form a hardenable cementitious composition.

15. The method of claim 14, wherein the base cementitious material comprises at least one of Portland cement, modified Portland cement, masonry cement, alumina cement, refractory cement, magnesium phosphate cement, magnesium potassium phosphate cement, calcium aluminate cement, calcium sulfoaluminate cement, calcium sulfate hemi-hydrate cement, oil well cement, ground granulated blast furnace slag cement, natural cement, hydraulic hydrated lime, or mixtures thereof.

16. The method of claim 14, wherein the base cementitious material comprises an aggregate component.

17. The method of claim 14, wherein the packaged additive comprises at least one of a set accelerator, set retarder, air-entraining agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, wetting agent, strength enhancing agent, toughening aid, thickening agent, density modifier, preservative, water repellent, or mixtures thereof.

18. The method of claim 14, wherein the packaged additive comprises admixture material components suitable to transform the base cementitious material into a customized cementitious material comprising end application dictated performance characteristics that are imparted by the admixture material, wherein the specialty cementitious material is selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.

19. A method for repairing a flaw in a cementitious structure comprising:
providing a base cementitious material and the packaged additive of claim 1;
mixing together the base cementitious material, the packaged additive, and water, and
allowing the water-soluble paper package to dissolve and the at least one non-liquid performance-enhancing additive packaged within the water-soluble paper package to mix with the base cementitious material and water to form a hardenable cementitious composition; and
applying the hardenable cementitious composition to the flaw.

20. The method of claim 19, wherein the base cementitious material comprises at least one of Portland cement, modified Portland cement, masonry cement, alumina cement, refractory cement, magnesium phosphate cement, magnesium potassium phosphate cement, calcium aluminate cement, calcium sulfoaluminate cement, calcium sulfate hemi-hydrate cement, oil well cement, ground granulated blast furnace slag cement, natural cement, hydraulic hydrated lime, or mixtures thereof.

21. The method of claim 19, wherein the base cementitious material comprises an aggregate component.

22. The method of claim 19, wherein the packaged additive comprises at least one of a set accelerator, set retarder, air-entraining agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, wetting agent, strength enhancing agent, toughening aid, thickening agent, density modifier, preservative, water repellent, or mixtures thereof.

23. The method of claim 19, wherein the packaged additive comprises admixture material components suitable to transform the base cementitious material into a customized cementitious material comprising end application dictated performance characteristics that are imparted by the admixture material, wherein the specialty cementitious material is selected from the group consisting of cementitious binders, concretes, grouts, mortars, cementitious adhesives, cementitious fireproofing compositions, cementitious flooring compositions, self-consolidating cementitious materials, screedable cementitious materials, trowel-applied antifracture and watertight cementitious membranes, vertical and overhead cementitious materials, self-leveling repair cementitious materials, form and pour concrete, form and pump concrete, pre-placed aggregate concrete, hand applied mortar, hand applied concrete, low-pressure spray-applied vertical and overhead repair cementitious material, screedable re-sloping topping or leveling cementitious material for inclined or horizontal surfaces, underwater grouting material, flexible crack isolation or waterproofing membranes, grouting materials, tuck-pointing materials, masonry assembly materials, and stuccoing materials.
